(19) United States
(12) Patent Application Publication
(10) Pub. No.: US 2024/0132707 A1
(43) Pub. Date: Apr. 25, 2024

(54) Fiber-Reinforced Propylene Composition Having Ultralow Emissions

(71) Applicant: Ticona LLC, Florence, KY (US)

(72) Inventors: David W. Eastep, Winona, MN (US); Uta Schoenwald-Otten, Rodenbach (DE); Gennaro Signorelli, Forli (IT)

(21) Appl. No.: 18/479,847

(22) Filed: Oct. 3, 2023

Related U.S. Application Data
(60) Provisional application No. 63/413,265, filed on Oct. 5, 2022.

(51) Int. Cl. C08L 23/14; C08J 5/24; C08K 7/14

(52) U.S. Cl. CPC C08L 23/14; C08J 5/244; C08K 7/14; C08J 2323/14

(57) ABSTRACT

A fiber-reinforced polymer composition that contains a polymer matrix and a plurality of long reinforcing fibers distributed within the polymer matrix is provided. The polymer matrix contains a propylene impact copolymer having a first melt flow rate of from about 10 to about 100 grams per 10 minutes and a metallocene-catalyzed propylene homopolymer having a second melt flow rate of from about 10 to about 100 grams per 10 minutes, wherein the ratio of the second melt flow rate to the first melt flow rate is from about 0.1 to about 2. The composition exhibits a toluene equivalent volatile organic content of about 50 μgC/g or less as determined in accordance with VDA 278:2002.

### RELATED APPLICATION

The present application is based upon and claims priority to U.S. Provisional Patent Application Ser. No. 63/413,265, having a filing date of Oct. 5, 2022, which is incorporated herein by reference.

### BACKGROUND OF THE INVENTION

Long fiber-reinforced polypropylene compositions are often employed in molded parts to provide improved mechanical properties. Typically, such compositions are formed by a process that involves extruding a propylene polymer through an impregnation die and onto a plurality of continuous lengths of reinforcing fibers. The polymer and reinforcing fibers are pulled through the die to cause thorough impregnation of individual fiber strands with the resin. Despite the benefits that can be achieved with such compositions, it is often difficult to effectively employ them in parts having a very thin wall thickness due to the low melt flow rate and poor mechanical properties of many conventional propylene polymers. While various attempts have been made to improve the flow properties of propylene polymers, these efforts tend to have an adverse impact on the organic volatile content that is emitted by the composition. As such, a need currently exists for a fiber-reinforced propylene composition for use in forming shaped parts that can exhibit good properties and yet still retain minimal volatile emissions.

### SUMMARY OF THE INVENTION

In accordance with one embodiment of the present invention, a fiber-reinforced polymer composition is disclosed that comprises a polymer matrix that constitute from about 30 wt. % to about 90 wt. % of the composition and a plurality of long reinforcing fibers that are distributed within the polymer matrix, wherein the fibers constitute from about 10 wt. % to about 70 wt. % of the composition. The polymer matrix contains a propylene impact copolymer having a first melt flow rate of from about 10 to about 100 grams per 10 minutes as determined in accordance with ISO 1133-1:2022 at a load of 2.16 kg and temperature of 230° C. and a metallocene-catalyzed propylene homopolymer having a second melt flow rate of from about 10 to about 100 grams per 10 minutes as determined in accordance with ISO 1133-1:2022 at a load of 2.16 kg and temperature of 230° C. The ratio of the second melt flow rate to the first melt flow rate is from about 0.1 to about 2. The composition exhibits a toluene equivalent volatile organic content of about 50 μgC/g or less as determined in accordance with VDA 278:2002.

Other features and aspects of the present invention are set forth in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a schematic illustration of one embodiment of a system that may be used to form the fiber-reinforced polymer composition of the present invention;

FIG. 2 is a cross-sectional view of an impregnation die that may be employed in the system shown in FIG. 1;

FIG. 3 is a perspective view of one embodiment of an automotive interior that may contain one or more parts formed from the fiber-reinforced polymer composition of the present invention; and

FIG. 4 is a perspective view of the door module shown in FIG. 3 and that may be formed from the fiber-reinforced polymer composition of the present invention.

Repeat use of reference characters in the present specification and drawings is intended to represent the same or analogous features or elements of the present invention.

### DETAILED DESCRIPTION OF REPRESENTATIVE EMBODIMENTS

It is to be understood by one of ordinary skill in the art that the present discussion is a description of exemplary embodiments only, and is not intended as limiting the broader aspects of the present invention.

Generally speaking, the present invention is directed to a fiber-reinforced composition for use in a shaped part (e.g., injection molded part) that contains a plurality of long reinforcing fibers distributed within a polymer matrix. Long fibers may, for example, constitute from about 10 wt. % to about 70 wt. %, in some embodiments from about 15 wt. % to about 65 wt. %, and in some embodiments, from about 20 wt. % to about 60 wt. % of the composition. Likewise, the polymer matrix typically constitutes from about 30 wt. % to about 90 wt. %, in some embodiments from about 35 wt. % to about 85 wt. %, and in some embodiments, from about 40 wt. % to about 80 wt. % of the composition. The polymer matrix contains at least one propylene impact copolymer and at least one metallocene-catalyzed propylene homopolymer. The propylene impact copolymer(s), for example, typically constitute from about 2 wt. % to about 35 wt. %, in some embodiments from about 5 wt. % to about 30 wt. %, and in some embodiments, from about 10 wt. % to about 25 wt. % of the polymer matrix, as well as from about 1 wt. % to about 30 wt. %, in some embodiments from about 2 wt. % to about 25 wt. %, and in some embodiments, from about 4 wt. % to about 20 wt. % of the entire polymer composition. The metallocene-catalyzed homopolymer(s) may likewise constitute from about 50 wt. % to about 95 wt. %, in some embodiments from about 60 wt. % to about 92 wt. %, and in some embodiments, from about 65 wt. % to about 90 wt. % of the polymer matrix, as well as from about 40 wt. % to about 85 wt. %, in some embodiments from about 45 wt. % to about 80 wt. %, and in some embodiments, from about 50 wt. % to about 70 wt. % of the entire polymer composition.

By selectively controlling the nature and concentration of the constituents of the polymer matrix and long reinforcing fibers, as well as the particular manner in which they are combined together, the present inventors have discovered that the resulting composition can achieve ultralow levels of emissions of volatile organic compounds. As used herein, the term “volatile compounds” or “volatiles” generally refer to organic compounds that have a relatively high vapor pressure. For example, the boiling point of such compounds at atmospheric pressure (1 atmosphere) may be about 80° C. or less, in some embodiments about 70° C. or less, and in some embodiments, from about 0° C. to about 60° C. One example of such a compound is 2-methyl-1-propene. The composition may also exhibit a toluene equivalent volatile content (“TVOC”) of about 50 micrograms equivalent toluene per gram of the composition (“μg/g”) or less, in some embodiments about 40 μg/g or less, and in some embodiments, from about 1 to about about 30 μg/g, as determined in accordance with VDA 278:2002. The fogging content (“FOG”) may likewise be about 250 micrograms hexadecane per gram of the composition (“μg/g”) or less, in some embodiments about 200 μg/g or less, and in some embodiments, from about 1 to about about 150 μg/g, as determined in accordance with VDA 278:2002. The polymer composition may also possess good olfactory characteristics. For example, the composition may exhibit an odor value of about 4.5 or less, in some embodiments about 4 or less, and in some embodiments, from about 2 to 3.5, as determined in accordance with VDA 270:2016.

Conventionally, it was believed that compositions with low emissions and odor could not also achieve sufficiently good mechanical properties. Nevertheless, the present inventors have discovered that the resulting composition can achieve good mechanical properties. For example, the composition may exhibit a high degree of impact strength, such as a Charpy notched impact strength of about 5 kJ/m² or more, in some embodiments about 10 kJ/m² or more, in some embodiments from about 10 kJ/m² to about 35 kJ/m², and in some embodiments, from about 15 kJ/m² to about 30 kJ/m², measured at 23° C. according to ISO 179-1:2010. The composition may also exhibit a Charpy unnotched impact strength of about 20 kJ/m² or more, in some embodiments about 30 KJ/m² or more, in some embodiments from about 45 to about 100 kJ/m², and in some embodiments, from about 50 to about 90 kJ/m², measured at 23° C. according to ISO 179-1:2010. The polymer composition may also exhibit good tensile and flexural properties. For example, the composition may exhibit a tensile strength of about 25 MPa or more, in some embodiments about 50 MPa or more, in some embodiments from about 60 MPa to about 150 MPa, and in some embodiments, from about 70 to about 120 MPa; a tensile elongation at break of about 1% or more, in some embodiments about 2% or more, and in some embodiments, from about 2.5% to about 5%; and/or a tensile modulus of about 2,000 MPa or more, in some embodiments about 4,000 MPa to about 15,000 MPa, and in some embodiments, from about 4,500 MPa to about 12,000 MPa. The tensile properties may be determined in accordance with ISO 527-1:2019 at 23° C. The composition may also exhibit a flexural modulus of about 2,000 MPa or more, in some embodiments from about 4,000 MPa to about 15,000 MPa, and in some embodiments, from about 4,500 MPa to about 12,000 MPa and/or a flexural strength of about 25 MPa or more, in some embodiments from about 50 to about 200 MPa, and in some embodiments, from about 100 to about 175 MPa. The flexural properties may be determined in accordance with ISO 178:2019 at 23° C.

The present inventors have also discovered that the polymer composition has good thermal stability. Namely, the polymer composition is not highly sensitive to low temperatures. For example, the mechanical properties (e.g., impact strength, tensile properties, and/or flexural properties) may remain within the ranges noted above even when tested at a temperature of −30° C. For example, the ratio of a particular mechanical property (e.g., Charpy unnotched impact strength, Charpy notched strength, tensile strength, flexural strength, etc.) at −30° C. to the mechanical property at 23° C. may be about 0.7 or more, in some embodiments about 0.8 or more, and in some embodiments, about 0.9 or more. In fact, in some embodiments, the mechanical property may actually be higher at −30° C. such that the ratio of a particular mechanical property (e.g., Charpy unnotched impact strength, Charpy notched strength, tensile strength, flexural strength, etc.) at −30° C. to the mechanical property at 23° C. is actually greater than 1, such as from 1 to about 1.5.

The fiber-reinforced composition may also have a high degree of fluidity, which enables it to be formed into relatively thin shaped parts (e.g., injection molded parts). For example, such parts may have a thickness of about 4 millimeters or less, in some embodiments about 2.5 millimeters or less, in some embodiments about 2 millimeters or less, in some embodiments about 1.8 millimeters or less, and in some embodiments, from about 0.4 to about 1.6 millimeters (e.g., 1.2 millimeters). When forming an injection molded part, for instance, a relatively high “spiral flow length” can be achieved. The term “spiral flow length” generally refers to the length reached by the flow of the composition in a spiral flow channel when it is injected at constant injection temperature and injection pressure from a central gate of a mold in which the spiral flow channel is formed. The spiral flow length may, for instance, be about 450 millimeters or more, in some embodiments about 600 millimeters or more, and in some embodiments, from about 650 to about 1,000 millimeters, as determined in accordance with ASTM D3121-09. The injection pressure that may be employed to shape the fiber-reinforced composition into an injection molded part may also be relatively low, such as about 750 bar or less, in some embodiments about 700 bar or less, and in some embodiments, from about 300 to about 650 bar.

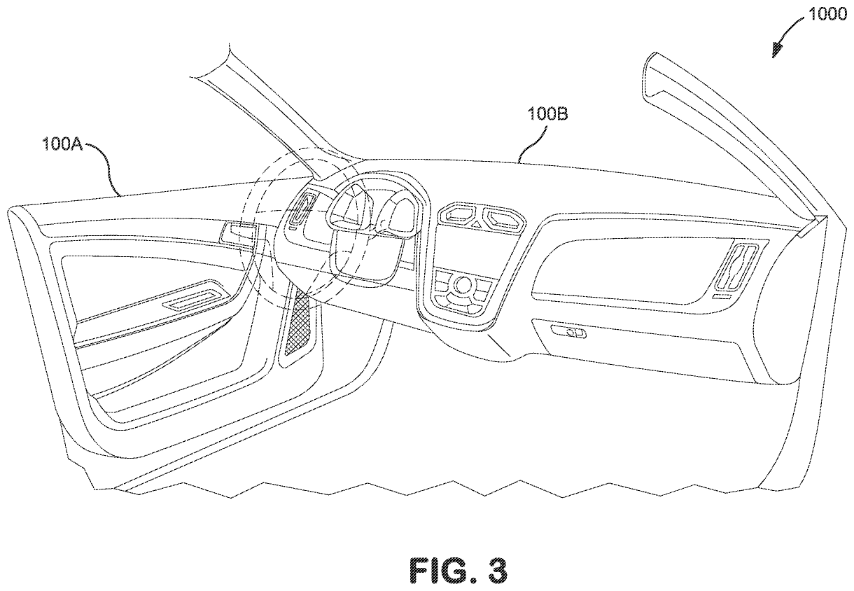

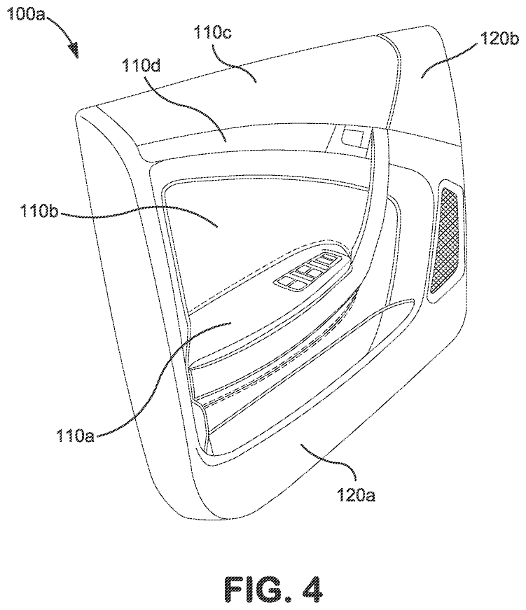

In light of the properties discussed above, the present inventors have discovered that the fiber-reinforced composition is particularly suitable for use in interior and exterior automotive parts (e.g., injection molded parts). Suitable exterior automotive parts may include fan shrouds, sunroof systems, door panels, front end modules, side body panels, underbody shields, bumper panels, cladding (e.g., near the rear door license plate), cowls, spray nozzle body, capturing hose assembly, pillar cover, rocker panel, etc. Likewise, suitable interior automotive parts that may be formed from the fiber-reinforced composition of the present invention may include, for instance, pedal modules, instrument panels (e.g., dashboards), arm rests, consoles (e.g., center consoles), seat structures (e.g., backrest of the rear bench or seat covers), interior modules (e.g., trim, body panel, or door module), lift gates, interior organizers, step assists, ash trays, glove boxes, gear shift levers, etc. Referring to FIG. 3, for example, one embodiment of an automotive interior 1000 is shown having an interior door module 100a and an instrument panel 100b, one or both of which may be formed entirely or in part from the fiber-reinforced polymer composition of the present invention. FIG. 4, for example, depicts a particular embodiment of the interior automotive module 100a that includes an arm rest component 110a, first padded component 110b, second padded component 110c, and trim component 110d. The door module 100a can also include a base component 120a and an accent component 120b. The base component 120a may be formed around each of the components of the automotive module 100a.

Various embodiments of the present invention will now be described in more detail.

### I. Polymer Matrix

A. Propylene Homopolymer

As noted, the polymer matrix contains at least one propylene homopolymer synthesized using a metallocene catalyst. The term “propylene homopolymer” generally refers to a propylene polymer that contains substantially only propylene units, such as about 99.0 wt. % or more, in some embodiments about 99.5 wt. % or more, and in some embodiments, about 99.8 wt. % or more of propylene units. In one particular embodiment, a “propylene homopolymer” is a polymer in which only propylene units in the propylene homopolymer are detectable. Examples of suitable metallocene catalysts may include, for instance, bis(n-butylcyclopentadienyl)titanium dichloride, bis(n-butylcyclopentadienyl)zirconium dichloride, bis(cyclopentadienyl)scandium chloride, bis(indenyl)zirconium dichloride, bis(methylcyclopentadienyl)titanium dichloride, bis(methylcyclopentadienyl)zirconium dichloride, cobaltocene, cyclopentadienyltitanium trichloride, ferrocene, hafnocene dichloride, isopropyl(cyclopentadienyl,-1-flourenyl)zirconium dichloride, molybdocene dichloride, nickelocene, niobocene dichloride, ruthenocene, titanocene dichloride, zirconocene chloride hydride, zirconocene dichloride, and the like. Polymers made using metallocene catalysts typically have a narrow molecular weight range, controlled short chain branching distribution, and controlled isotacticity. For example, the metallocene-catalyzed propylene homopolymer may have a narrow molecular weight distribution (Mw/Mn) of less than about 5.0, in some embodiments less than about 4.0, in some embodiments less than about 3.5, and in some embodiments, from about 1.5 to about 3.0.

The metallocene-catalyzed propylene homopolymer generally has a relatively low melt flow rate, such as from about 10 to about 100 grams per 10 minutes, in some embodiments from about 15 to about 80 grams per 10 minutes, and in some embodiments, from about 20 to about 70 grams per 10 minutes as determined in accordance with ISO 1133-1:2022 at a load of 2.16 kilograms and temperature of about 230° C. The propylene homopolymer may likewise exhibit a relatively high flexural modulus, such as about 800 MPa or more, in some embodiments, from about 1,000 MPa or greater, and in some embodiments, from about 1,200 MPa to about 2,000 MPa, such as determined in accordance with ISO 178:2019. The density of the homopolymer may likewise be about 0.95 grams per cubic centimeter (g/cm³) or less, in some embodiments from about 0.8 to about 0.93 g/cm³, and in some embodiments, from about 0.85 to about 0.92 g/cm³, such as determined in accordance with ISO 1183-1:2019.

To achieve the desired properties, the propylene homopolymer may be an isotactic or syndiotactic homopolymer. The term “syndiotactic” generally refers to a tacticity in which a substantial portion, if not all, of the methyl groups alternate on opposite sides along the polymer chain. On the other hand, the term “isotactic” generally refers to a tacticity in which a substantial portion, if not all, of the methyl groups are on the same side along the polymer chain. In some embodiments, the metallocene catalyzed-propylene homopolymer may be isotactic. For example, the polymer can have an mmmm pentad content of at least about 93%, in some embodiments about 95% or greater, and in some embodiments, from about 97% to about 99%, such as determined by NMR analysis according to the method described by G. J. Ray et al. in Macromolecules, vol. 10, nº 4, 1977, p. 773-778. The metallocene-catalyzed propylene homopolymer may also have a crystallinity from about 35% to about 70%, in some embodiments from about 40% to about 60%, and in some embodiments, from about 45% to about 55%. Crystallinity may be measured by differential scanning calorimetry (“DSC”) techniques using the following equation, % crystallinity=ΔHf/ΔHf*, where ΔHf and ΔHf* refer to the melting enthalpies of the resins and propylene homopolymers with 100% crystallinity. The crystallization temperature of the metallocene-catalyzed propylene homopolymer may likewise be from about 100° C. to about 135° C., in some embodiments from about 105° C. to about 125° C., and in some embodiments, from about 107° C. to about 115° C. Crystallization temperature can be determined by DSC analysis using a heating and cooling rate of 20° C./min after erasing thermal history by heating to 200° C. and maintaining the temperature for 3 minutes. The metallocene-catalyzed propylene homopolymer also have a relatively low melting temperature. For example, the metallocene-catalyzed propylene homopolymer can have a melting temperature of less than about 180° C., in some embodiments less than about 165° C., and in some embodiments, from about 145° C. to about 155° C., such as determined in accordance with DSC analysis.

B. Propylene Impact Copolymer

In addition to a metallocene-catalyzed propylene homopolymer, the polymer matrix also contains at least one propylene impact copolymer. The propylene impact copolymer also generally has a relatively low melt flow rate, such as from about 10 to about 100 grams per 10 minutes, in some embodiments from about 15 to about 80 grams per 10 minutes, and in some embodiments, from about 20 to about 70 grams per 10 minutes as determined in accordance with ISO 1133-1:2022 at a load of 2.16 kilograms and temperature of about 230° C. Notably, the ratio of the melt flow rate of the metallocene-catalyzed homopolymer (“second melt flow rate”) to the melt flow rate of the propylene impact copolymer (“first melt flow rate”) may be selectively controlled to achieve a unique combination of low emissions, low odor, and good mechanical properties, particularly at cold temperatures (e.g., −30° C.). For example, the ratio of the second melt flow rate to the first melt flow rate may be from about 0.1 to about 2, in some embodiments from about 0.2 to about 1.8, and in some embodiments, from about 0.4 to about 1.5. The propylene impact copolymer may likewise exhibit a relatively high flexural modulus, such as about 800 MPa or more, in some embodiments, from about 1,000 MPa or greater, and in some embodiments, from about 1,200 MPa to about 2,000 MPa, such as determined in accordance with ISO 178:2019. The density of the propylene impact copolymer may likewise be about 0.95 grams per cubic centimeter (g/cm³) or less, in some embodiments from about 0.8 to about 0.93 g/cm³, and in some embodiments, from about 0.85 to about 0.92 g/cm³, such as determined in accordance with ISO 1183-1:2019.

In certain embodiments, the propylene impact copolymer may be considered “homophasic” in that it contains only one phase. In such embodiments, the propylene copolymer may contain one or more propylene monomers in combination with one or more α-olefin comonomers other than propylene. Examples of such α-olefin comonomers may include C₃-C₁₂ olefin monomers, such as instance, ethylene, propylene, 1-butene, 1-pentene, 1-hexene, 1-heptene, 1-octene, 1-nonene, 1-decene, 1-undecene, 1-dodecene, etc., as well as combinations thereof. For a homophasic copolymer, such α-olefin comonomers typically constitute from about 1 mol. % to about 50 mol. %, in some embodiments from about 5 mol. % to about 40 mol. %, and in some embodiments, from about 10 mol. % to about 35 mol. % of the copolymer, and propylene monomers likewise typically constitute from about 50 mol. % to about 99 mol. %, in some embodiments from about 60 mol. % to about 95 mol. %, and in some embodiments, from about 65 mol. % to about 90 mol. % of the copolymer.

In other embodiments, the propylene impact copolymer may be considered “heterophasic” in that it contains at least two major component phases—a continuous phase and a dispersed phase. The continuous phase may constitute from about 50 wt. % to about 95 wt. %, in some embodiments from about 60 wt. % to about 94 wt. %, and in some embodiments, from about 70 wt. % to about 92 wt. % of the copolymer, and the dispersed phase may likewise constitute from about 5 wt. % to about 50 wt. %, in some embodiments from about 6 wt. % to about 40 wt. %, and in some embodiments, from about 8 wt. % to about 30 wt. % of the copolymer. Furthermore, the “β/α ratio”, which is defined in more detail below and generally represents the ratio of the dispersed phase molecular weight to the continuous phase molecular weight of a heterophasic copolymer, is typically about 1.1 or less, in some embodiments about 1.05 or less, and in some embodiments, from about 0.1 to about 1. The continuous phase typically includes at least one propylene polymer that contains one or more propylene monomers and optionally one or more α-olefin comonomers other than propylene, such as described above. When employed, such α-olefin comonomers may constitute from about 0 mol. % to about 6 mol. %, in some embodiments from about 0.1 mol. % to about 4 mol. %, and in some embodiments, from about 0.5 mol. % to about 3.5 mol. % of the propylene polymer. In one particular embodiment, the continuous phase includes one or more propylene homopolymers such as described above.

The dispersed phase of a heterophasic copolymer may contain at least one olefin copolymer, such as a propylene copolymer that contains one or more propylene monomers and one or more α-olefin comonomers (e.g., C₃-C₁₂ olefin monomers) other than propylene and/or an ethylene copolymer that contains one or more ethylene comonomers and one or more α-olefin comonomers (e.g., C₃-C₁₂ olefin monomers) other than ethylene. Typically, the α-olefin comonomers constitute from about 5 wt. % to about 65 wt. %, in some embodiments from about 10 wt. % to about 50 wt. %, and in some embodiments, from about 15 wt. % to about 40 wt. % of the copolymer. In certain embodiments, the dispersed phase may contain a blend of copolymers, such as a first copolymer of ethylene and an α-olefin and a second copolymer of ethylene and an α-olefin. The first copolymer may, for instance, contain ethylene monomers in an amount of from about 35 wt. % to about 85 wt. %, in some embodiments from about 50 wt. % to about 70 wt. %, and in some embodiments, from about 60 wt. % to about 65 wt. % of the first copolymer, and C₃-C₁₂ α-olefin monomers in an amount of from about 15 wt. % to about 65 wt. %, in some embodiments from about 30 wt. % to about 50 wt. %, and in some embodiments, from about 35 wt. % to about 40 wt. % of the first copolymer. In particular embodiments, the α-olefin monomers of the first copolymer may include 1-octene, 1-hexene, 1-butene, and/or propylene. The second copolymer may likewise contain ethylene monomers in an amount of from about 65 wt. % to about 95 wt. %, in some embodiments from about 75 wt. % to about 94 wt. %, and in some embodiments, from about 85 wt. % to about 92 wt. % of the second copolymer, and C₃-C₁₂ α-olefin monomers in an amount of from about 5 wt. % to about 35 wt. %, in some embodiments from about 6 wt. % to about 25 wt. %, and in some embodiments, from about 8 wt. % to about 15 wt. % of the second copolymer. In particular embodiments, the α-olefin monomers of the second copolymer may include 1-octene, 1-hexene, 1-butene, and/or propylene. In one particular embodiment, the first and second copolymers are each ethylene/propylene copolymers. When employed, the first copolymer may constitute from about 40 wt. % to about 90 wt. %, in some embodiments from about 50 wt. % to about 80 wt. %, and in some embodiments, from about 60 wt. % to about 70 wt. % of the dispersed phase, and the second copolymer may constitute from about 10 wt. % to about 60 wt. %, in some embodiments from about 20 wt. % to about 50 wt. %, and in some embodiments, from about 30 wt. % to about 40 wt. % of the dispersed phase. In certain cases, the first copolymer may be present in an amount greater than the second copolymer.

While a variety of processes may be used to form the propylene impact copolymer, such polymers are typically formed by an in-reactor process. As used herein, the term “in-reactor” generally means that the polymer is polymerized without the need for post-polymerization blending (although the resultant copolymer can undergo poly-polymerization blending, for example, to incorporate modifiers, additives, or additional blend components). For example, this may be accomplished by polymerizing the monomer(s) (e.g., propylene) to be used as the continuous phase in a first reactor in the presence of a polymerization catalyst and transferring the resulting polymer from the first reactor into a second reactor where the monomers comprising the dispersed phase are polymerized in the presence of the continuous phase. Alternatively, the polymer from the first reactor may be sequentially transferred to a second and third reactor where monomers for synthesizing the first copolymer and the second copolymer, respectively, may be polymerized to form the dispersed phase. It should be understood that “first”, “second”, and “third” reactors are simply used to designate whether the reactor produces the continuous phase (reactor 1) or the dispersed phase (reactor 2 and optionally reactor 3), but that each “reactor” may include more than one physical reactor and be situated in any order. The impact copolymer may be prepared using a two-step process in which each step may be independently carried out in a gas phase reactor, fluidized bed reactor, or other particle forming process or reactor. For example, the first step may be conducted in a gas phase reactor or other particle forming process. In specific embodiments, the dispersed phase is polymerized in a second, gas phase reactor.

The impact copolymer may be formed using a Ziegler Natta polymerization catalyst, such as a non-metallocene Ziegler Natta catalyst, a homo- or heterogeneous Ziegler Natta catalyst, or a supported Ziegler Natta catalyst and including, for example any necessary co-catalyst. According to certain embodiments, the polymerization catalyst may be the same catalyst throughout the polymerization process. That is, the polymerization catalyst may be transferred from the first reactor to the second reactor (and/or subsequent reactors) along with the polymeric material formed in the reactor. Suitable catalysts include commercially available and non-commercially available Ziegler Natta (“ZN”) catalysts, such as ZN catalysts suitable for use in SPHERIPOL® type polymerization processes, UNIPOL™ type polymerization processes, NOVOLEN® type polymerization processes, INNOVENE® type polymerization processes, Chisso type polymerization processes, and Spherizone type processes. Such catalyst may include but are not limited to SHAC™ catalyst systems, UCAT™ catalysts systems, LYNX®, CD®, and PTK® catalyst systems, and other third and higher generation ZN catalysts. As is known in the art, hydrogen may be added to any of the reactors to control molecular weight, intrinsic viscosity and melt flow rate (MFR) of the polymeric composition within the reactor.

Regardless of the particular manner in which it is formed, the propylene impact copolymer may have a softening temperature of less than about 180° C., in some embodiments less than about 165° C., and in some embodiments, from about 145° C. to about 155° C., such as determined in accordance with ISO 306:2004 (Method A, force of 10N).

C. Impact Modifier

In addition to a metallocene-catalyzed propylene homopolymer and propylene impact copolymer, the polymer matrix may optionally contain an impact modifier to enhance the degree of adhesion between the long fibers and the homopolymer/copolymer of the polymer matrix. When employed, such impact modifiers typically constitute from about 1 wt. % to about 30 wt. %, in some embodiments from about 2 wt. % to about 25 wt. %, and in some embodiments, from about 5 wt. % to about 20 wt. % of the polymer matrix, as well as from about 0.5 wt. % to about 25 wt. %, in some embodiments from about 1 wt. % to about 20 wt. %, and in some embodiments, from about 4 wt. % to about 15 wt. % of the entire polymer composition.

Generally speaking, the impact modifier includes an olefin elastomer having a relatively low melt flow rate, such as from about 0.1 to about 50 grams per 10 minutes, in some embodiments from about 0.5 to about 30 grams per 10 minutes, and in some embodiments, from about 1 to about 10 grams per 10 minutes as determined in accordance with ISO 1133-1:2022 at a load of 2.16 kilograms and temperature of about 190° C. for ethylene-based polymers and 230° C. for propylene-based polymers. The elastomer may also have a Shore A hardness of about 200 or less, in some embodiments from about 10 to about 150, and in some embodiments, from about 20 to about 100, such as determined in accordance with ASTM D2240-15(2021). The olefin elastomer may likewise exhibit a relatively low flexural modulus, such as about 100 MPa or less, in some embodiments, about 50 MPa or less, and in some embodiments, from about 1 MPa to about 25 MPa, such as determined in accordance with ISO 178:2019. The density of the olefin elastomer may likewise be about 0.95 grams per cubic centimeter (g/cm³) or less, in some embodiments from about 0.8 to about 0.93 g/cm³, and in some embodiments, from about 0.84 to about 0.9 g/cm³, such as determined in accordance with ISO 1183-1:2019. For example, the olefin elastomer may have a melting temperature of less than about 120° C., in some embodiments less than about 100° C., and in some embodiments, from about 30° C. to about 80° C., such as determined in accordance by DSC analysis.

Any of a variety of olefin elastomers may be employed. In one embodiment, for example, the olefin elastomer may contain one or more ethylene monomers in combination with one or more α-olefin comonomers other than ethylene, such as described above. Examples of such α-olefin comonomers may include C₃-C₁₂ olefin monomers, such as instance, ethylene, propylene, 1-butene, 1-pentene, 1-hexene, 1-heptene, 1-octene, 1-nonene, 1-decene, 1-undecene, 1-dodecene, etc., as well as combinations thereof. Ethylene-octene copolymer elastomers may be particularly suitable. Although by no means required, it may also be particularly desirable that the olefin elastomer is formed using a metallocene catalyst as described above. If desired, the olefin elastomer may also be modified with a polar functional group. Such olefin elastomers may be an olefin homopolymer (e.g., polypropylene) or copolymer (e.g., ethylene copolymer, propylene copolymer, etc.) in which a functional group is grafted onto the polyolefin backbone or incorporated as a monomeric constituent of the polymer (e.g., block or random copolymers), etc. Particularly suitable functional groups include maleic anhydride, maleic acid, fumaric acid, maleimide, maleic acid hydrazide, a reaction product of maleic anhydride and diamine, dichloromaleic anhydride, maleic acid amide, etc.

D. Other Additives

If desired, the polymer matrix may also contain a wide variety of other additives to help provide the desired combination of ultralow emission and good mechanical properties under various conditions. Such additives may be blended with the propylene homopolymer and/or propylene impact copolymer before or after such polymers are combined together. The additives may also be incorporated into one or more of such polymers during their formation, such as being incorporated into the continuous and/or dispersed phase of a heterophasic propylene impact copolymer.

In one embodiment, for example, the polymer matrix may contain a a stabilizer system to help maintain the desired surface appearance and/or mechanical properties even after being exposed to ultraviolet light and high temperatures. For example, the stabilizer system may include a variety of different antioxidants (e.g., sterically hindered phenol antioxidant, phosphite antioxidant, thioester antioxidant, etc.), ultraviolet light stabilizers, light stabilizers, heat stabilizers, and so forth.

If desired, one or more antioxidants may be employed in the stabilizer system. In particularly suitable embodiments, a combination of antioxidants are employed to help provide a synergistic effect on the properties of the composition. In one embodiment, for instance, the stabilizer system may employ a combination of at least one sterically hindered antioxidant, phosphite antioxidant, and thioester antioxidant. When employed, the weight ratio of the phosphite antioxidant to the hindered phenol antioxidant may range from about 1:1 to about 5:1, in some embodiments from about 1:1 to about 4:1, and in some embodiments, from about 1.5:1 to about 3:1 (e.g., about 2:1). The weight ratio of the thioester stabilizer to the phosphite antioxidant is also generally from about 1:1 to about 5:1, in some embodiments from about 1:1 to about 4:1, and in some embodiments, from about 1.5:1 to about 3:1 (e.g., about 2:1). Likewise, the weight ratio of the thioester antioxidant to the hindered phenol antioxidant is also generally from about 2:1 to about 10:1, in some embodiments from about 2:1 to about 8:1, and in some embodiments, from about 3:1 to about 6:1 (e.g., about 4:1). Within these selected ratios, it is believed that the composition is capable of achieving a unique ability to remain stable even after exposure to high temperatures and/or ultraviolet light.

When employed, sterically hindered phenols are typically present in an amount of from about 0.01 to about 1 wt. %, in some embodiments from about 0.02 wt. % to about 0.5 wt. %, and in some embodiments, from about 0.05 wt. % to about 0.3 wt. % of the polymer composition. While a variety of different compounds may be employed, particularly suitable hindered phenol compounds are those having one of the following general structures (IV), (V) and (VI):

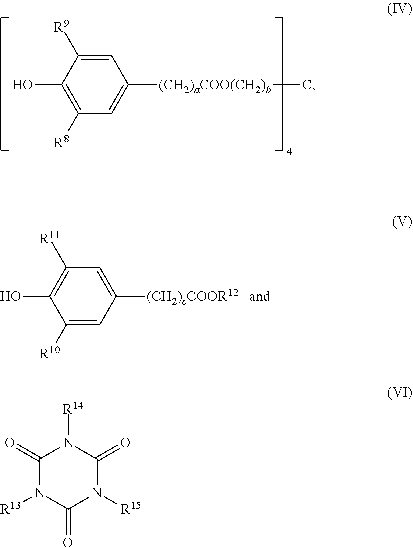

wherein,
   a, b and c independently range from 1 to 10, and in some embodiments, from 2 to 6;
   R⁸, R⁹, R¹⁰, R¹¹, and R¹² are independently selected from hydrogen, C₁ to C₁₀ alkyl, and C₃ to C₃₀ branched alkyl, such as methyl, ethyl, propyl, isopropyl, butyl, or tertiary butyl moieties; and
   R¹³, R¹⁴ and R¹⁵ are independently selected from moieties represented by one of the following general structures (VII) and (VIII):

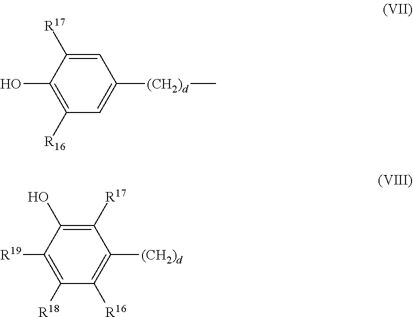

wherein,
   d ranges from 1 to 10, and in some embodiments, from 2 to 6;
   R¹⁶, R¹⁷, R¹⁸, and R¹⁹ are independently selected from hydrogen, C₁ to C₁₀ alkyl, and C₃ to C₃₀ branched alkyl, such as methyl, ethyl, propyl, isopropyl, butyl, or tertiary butyl moieties.

Specific examples of suitable hindered phenols having a general structure as set forth above may include, for instance, 2,6-di-tert-butyl-4-methylphenol; 2,4-di-tert-butyl-phenol; pentaerythrityl tetrakis(3,5-di-tert-butyl-4-hydroxyphenyl)propionate; octadecyl-3-(3′,5′-di-tert-butyl-4′-hydroxyphenyl)propionate; tetrakis[methylene(3,5-di-tert-butyl-4-hydroxycinnamate)]methane; bis-2,2′-methylene-bis(6-tert-butyl-4-methylphenol)terephthalate; 1,3,5-trimethyl-2,4,6-tris(3,5-di-tert-butyl-4-hydroxybenzyl)benzene; tris(3,5-di-tert-butyl-4-hydroxybenzyl)isocyanurate; 1,3,5-tris(4-tert-butyl-3-hydroxy-2,6-dimethylbenzyl)1,3,5-triazine-2,4,6-(1H,3H,5H)-trione; 1,1,3-tris(2-methyl-4-hydroxy-5-tert-butylphenyl)butane; 1,3,5-triazine-2,4,6(1H,3H,5H)-trione; 1,3,5-tris[[3,5-bis-(1,1-dimethylethyl)-4-hydroxyphenyl]methyl]; 4,4′,4″-[(2,4,6-trimethyl-1,3,5-benzenetriyl)tris-(methylene)]tris[2,6-bis(1,1-dimethylethyl)]; 6-tert-butyl-3-methylphenyl; 2,6-di-tert-butyl-p-cresol; 2,2′-methylenebis(4-ethyl-6-tert-butylphenol); 4,4′-butylidenebis(6-tert-butyl-m-cresol); 4,4′-thiobis(6-tert-butyl-m-cresol); 4,4′-dihydroxydiphenyl-cyclohexane; alkylated bisphenol; styrenated phenol; 2,6-di-tert-butyl-4-methylphenol; n-octadecyl-3-(3′,5′-di-tert-butyl-4′-hydroxyphenyl)propionate; 2,2′-methylenebis(4-methyl-6-tert-butylphenol); 4,4′-thiobis(3-methyl-6-tert-butylphenyl); 4,4′-butylidenebis(3-methyl-6-tert-butylphenol); stearyl-β-(3,5-di-tert-butyl-4-hydroxyphenyl)propionate; 1,1,3-tris(2-methyl-4-hydroxy-5-tert-butylphenyl)butane; 1,3,5-trimethyl-2,4,6-tris(3,5-di-tert-butyl-4-hydroxybenzyl)benzene; tetrakis[methylene-3-(3′,5′-di-tert-butyl-4′-hydroxyphenyl)propionate]methane, stearyl 3,5-di-tert-butyl-4-hydroxyhydocinnamate; and so forth, as well as mixtures thereof.

Particularly suitable compounds are those having the general structure (VI), such as tris(3,5-di-tert-butyl-4-hydroxybenzyl)isocyanurate, which is commercially available under the designation Irganox® 3114.

When employed, phosphite antioxidants are typically present in an amount of from about 0.02 to about 2 wt. %, in some embodiments from about 0.04 wt. % to about 1 wt. %, and in some embodiments, from about 0.1 wt. % to about 0.6 wt. % of the polymer composition. The phosphite antioxidant may include a variety of different compounds, such as aryl monophosphites, aryl disphosphites, etc., as well as mixtures thereof. For example, an aryl diphosphite may be employed that has the following general structure (IX):

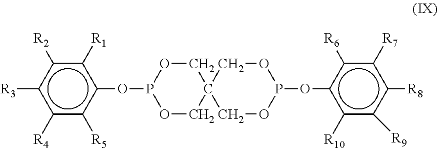

wherein,
   R₁, R₂, R₃, R₄, R₅, R₆, R₇, R₈, R₉, and R₁₀ are independently selected from hydrogen, C₁ to C₁₀ alkyl, and C₃ to C₃₀ branched alkyl, such as methyl, ethyl, propyl, isopropyl, butyl, or tertiary butyl moieties.

Examples of such aryl diphosphite compounds include, for instance, bis(2,4-dicumylphenyl)pentaerythritol diphosphite (commercially available as Doverphos® S-9228) and bis(2,4-di-t-butylphenyl)pentaerythritol diphosphite (commercially available as Ultranox® 626). Likewise, suitable aryl monophosphites may include tris(2,4-di-tert-butylphenyl)phosphite (commercially available as Irgafos® 168); bis(2,4-di-tert-butyl-6-methylphenyl) ethyl phosphite (commercially available as Irgafos® 38); and so forth.

When employed, thioester antioxidants are also typically present in an amount of from about 0.04 to about 4 wt. %, in some embodiments from about 0.08 wt. % to about 2 wt. %, and in some embodiments, from about 0.2 wt. % to about 1.2 wt. % of the polymer composition. Particularly suitable thioester antioxidants for use in the present invention are thiocarboxylic acid esters, such as those having the following general structure:

R₁₁—O(O)(CH₂)ₓ—S—(CH₂)_{y}(O)O—R₁₂
wherein,
   x and y are independently from 1 to 10, in some embodiments 1 to 6, and in some embodiments, 2 to 4 (e.g., 2);
   R₁₁, and R₁₂ are independently selected from linear or branched, C₆ to C₃₀ alkyl, in some embodiments C₁₀ to C₂₄ alkyl, and in some embodiments, C₁₂ to C₂₀ alkyl, such as lauryl, stearyl, octyl, hexyl, decyl, dodecyl, oleyl, etc.

Specific examples of suitable thiocarboxylic acid esters may include for instance, distearyl thiodipropionate (commercially available as Irganox® PS 800), dilauryl thiodipropionate (commercially available as Irganox® PS 802), di-2-ethylhexyl-thiodipropionate, diisodecyl thiodipropionate, etc.

The polymer matrix may also contain one or more UV stabilizers. Suitable UV stabilizers may include, for instance, benzophenones, such as a 2-hydroxybenzophenone (e.g., 2-hydroxy-4-octyloxy benzophenone (Chimassorb® 81), benzotriazoles (e.g., 2-(2-hydroxy-3,5-di-α-cumylphenyl)-2H-benzotriazole (Tinuvin® 234), 2-(2-hydroxy-5-tert-octylphenyl)-2H-benzotriazole (Tinuvin® 329), 2-(2-hydroxy-3-α-cumyl-5-tert-octylphenyl)-2H-benzotriazole (Tinuvin® 928), etc.), triazines (e.g., 2,4-diphenyl-6-(2-hydroxy-4-hexyloxyphenyl)-s-triazine (Tinuvin® 1577)), sterically hindered amines (e.g., bis(2,2,6,6-tetramethyl-4-piperidyl)sebacate (Tinuvin® 770) or a polymer of dimethyl succinate and 1-(2-hydroxyethyl)-4-hydroxy-2,2,6,6-tetramethyl-4-piperidine (Tinuvin®622)), and so forth, as well as mixtures thereof. When employed, such UV stabilizers typically constitute from about 0.05 wt. % to about 2 wt. % in some embodiments from about 0.1 wt. % to about 1.5 wt. %, and in some embodiments, from about 0.2 wt. % to about 1.0 wt. % of the composition.

If desired, the polymer matrix may also contain a carbon material to help impart color stability after exposure to ultraviolet light and/or high temperatures. The carbon material generally includes a plurality of carbon particles, such as carbon black, carbon nanotubes, and so forth. Carbon black may be particularly suitable, such as furnace black, channel black, acetylene black, or lamp black. The carbon particles may have any desired shape, such as a granular, flake (scaly), etc. The average size (e.g., diameter) of the carbon particles may be relatively small, such as from about 1 to about 200 nanometers, in some embodiments from about 5 to about 150 nanometers, and in some embodiments, from about 10 to about 100 nanometers. It is also typically desired that the carbon particles are relatively pure, such as containing polynuclear aromatic hydrocarbons (e.g., benzo[a]pyrene, naphthalene, etc.) in an amount of about 1 part per million (“ppm”) or less, and in some embodiments, about 0.5 ppm or less. For example, the carbon particles may contain benzo[a]pyrene in an amount of about 10 parts per billion (“ppb”) or less, and in some embodiments, about 5 ppb or less. If desired, the particles may also have a high specific surface area, such as from about 20 square meters per gram (m²/g) to about 1,000 m²/g, in some embodiments from about 25 m²/g to about 500 m²/g, and in some embodiments, from about 30 m²/g to about 300 m²/g. Surface area may be determined by the physical gas adsorption (BET) method (nitrogen as the adsorption gas) in accordance with ASTM D6556-19a. Without intending to be limited by theory, it is believed that particles having such a small size, high purity, and/or high surface area may improve the adsorption capability for many free radicals, which can minimize oxidation of the thermoplastic polymer.

If desired, the carbon material may include a carrier resin that can encapsulate the carbon particles, thereby providing a variety of benefits. For example, the carrier resin can enhance the ability of the particles to be handled and incorporated into the polymer matrix. While any known carrier resin may be employed for this purpose, in particular embodiments, the carrier resin may be an olefin polymer such as described above (e.g., propylene polymer), which may be the same or different than an olefin polymer employed in the polymer matrix. If desired, the carrier resin may be pre-blended with the carbon particles to form a masterbatch, which can later be combined with the polymer matrix. When employed, the carrier resin typically constitutes from about 40 wt. % to about 90 wt. %, in some embodiments from about 50 wt. % to about 80 wt. %, and in some embodiments, from about 60 wt. % to about 70 wt. % of the masterbatch, and the carbon particles typically constitute from about 10 wt. % to about 60 wt. %, in some embodiments from about 20 wt. % to about 50 wt. %, and in some embodiments, from about 30 wt. % to about 40 wt. % of the masterbatch. The relative concentration of the carbon particles and the carrier resin may be selectively controlled in the present invention to achieve the desired antioxidant behavior without adversely impacting the mechanical properties of the polymer composition. For example, the carbon particles are typically employed in an amount of from about from about 0.2 to about 2 wt. %, in some embodiments from about 0.25 to about 1.5 wt. %, and in some embodiments, from about 0.3 to about 1 wt. % of the entire polymer composition. The carbon material, which may contain a carrier resin, may likewise constitute from about 0.4 wt. % to about 4 wt. %, in some embodiments from about 0.5 wt. % to about 3 wt. %, and in some embodiments, from about 0.6 wt. % to about 2 wt. % of the polymer composition.

In addition to the components noted above, the polymer matrix may also contain a variety of other components. Examples of such optional components may include, for instance, odor masking agents, particulate fillers, lubricants, colorants, flow modifiers, pigments, and other materials added to enhance properties and processability. Suitable pigments may include, for instance, titanium dioxide, ultramarine blue, cobalt blue, phthalocyanines, anthraquinones, black pigments, metallic pigments, etc. When employing a black pigment, the carbon material noted above may also function as the pigment and/or or an additional black pigment may be employed.

As noted above, a blend of polymers is employed within the polymer matrix (e.g., propylene homopolymer and propylene impact copolymer). In Each of the polymers employed in the blend may be melt blended in a manner know in the art. During a melt blending process, for example, the raw materials may be supplied either simultaneously or in sequence to a melt-blending device that dispersively blends the materials. Batch and/or continuous melt blending techniques may be employed. For example, a mixer/kneader, Banbury mixer, Farrel continuous mixer, single-screw extruder, twin-screw extruder, roll mill, etc., may be utilized to blend the materials. One particularly suitable melt-blending device is a co-rotating, twin-screw extruder (e.g., ZSK-30 twin-screw extruder available from Werner & Pfleiderer Corporation of Ramsey, N.J.). Regardless of the particular melt blending technique chosen, the raw materials may be blended under high shear/pressure and heat to ensure sufficient mixing. For example, melt blending may occur at a temperature of from about 150° C. to about 300° C., in some embodiments, from about 155° C. to about 250° C., and in some embodiments, from about 160° C. to about 220° C. Melt blending of the polymers may occur prior to, during, and/or after incorporation of the long fibers. In particular embodiments, for example, it may be desired to melt process a first polymer (e.g., propylene impact copolymer) with one or more optional additives (e.g., impact modifier, stabilizers, pigments, etc.) to form a concentrate, which is then reinforced with long fibers in the manner described below to form a precursor composition. The precursor composition may thereafter be blended down (e.g., dry blended) with a second polymer (e.g., metallocene-catalyzed homopolymer) and one or more optional additives (e.g., impact modifier, stabilizers, pigments, etc.) to form the resulting polymer composition.

### II. Long Fibers

To form the fiber-reinforced composition of the present invention, long fibers are generally embedded within the polymer matrix. The term “long fibers” generally refers to fibers, filaments, yarns, or rovings (e.g., bundles of fibers) that are not continuous and have a length of from about 1 to about 25 millimeters, in some embodiments, from about 1.5 to about 20 millimeters, in some embodiments from about 2 to about 15 millimeters, and in some embodiments, from about 3 to about 12 millimeters. As noted above, due to the unique properties of the composition, a substantial portion of the fibers may maintain a relatively large length even after being formed into a shaped part (e.g., injection molding). That is, the median length (D50) of the fibers in the composition may be about 1 millimeter or more, in some embodiments about 1.5 millimeters or more, in some embodiments about 2.0 millimeters or more, and in some embodiments, from about 2.5 to about 8 millimeters.

The fibers may be formed from any conventional material known in the art, such as metal fibers; glass fibers (e.g., E-glass, A-glass, C-glass, D-glass, AR-glass, R-glass, S1-glass, S2-glass), carbon fibers (e.g., graphite), boron fibers, ceramic fibers (e.g., alumina or silica), aramid fibers (e.g., Kevlar®), synthetic organic fibers (e.g., polyamide, polyethylene, paraphenylene, terephthalamide, polyethylene terephthalate and polyphenylene sulfide), and various other natural or synthetic inorganic or organic fibrous materials known for reinforcing thermoplastic compositions. Glass fibers and carbon fibers are particularly desirable. Such fibers often have a nominal diameter of about 4 to about 35 micrometers, and in some embodiments, from about 9 to about 35 micrometers. The fibers may be twisted or straight. If desired, the fibers may be in the form of rovings (e.g., bundle of fibers) that contain a single fiber type or different types of fibers. Different fibers may be contained in individual rovings or, alternatively, each roving may contain a different fiber type. For example, in one embodiment, certain rovings may contain carbon fibers, while other rovings may contain glass fibers. The number of fibers contained in each roving can be constant or vary from roving to roving. Typically, a roving may contain from about 1,000 fibers to about 50,000 individual fibers, and in some embodiments, from about 2,000 to about 40,000 fibers.

### III. Technique for Forming the Fiber-Reinforced Composition

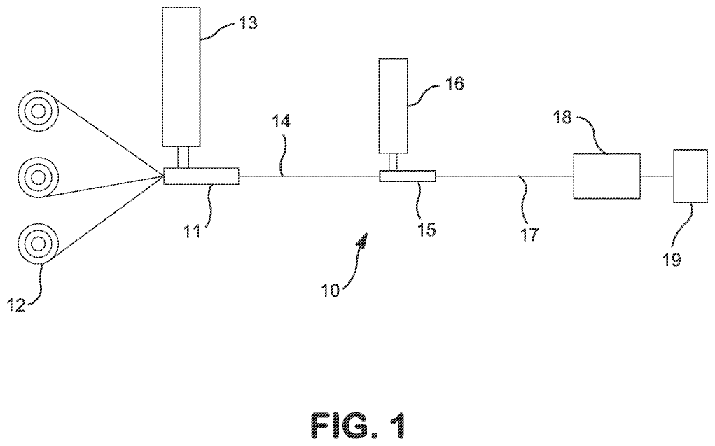

Any of a variety of different techniques may generally be employed to incorporate the fibers into the polymer matrix. The long fibers may be randomly distributed within the polymer matrix, or alternatively distributed in an aligned fashion. In one embodiment, for instance, continuous fibers may initially be impregnated into the polymer matrix to form strands, which are thereafter cooled and then chopped into pellets to that the resulting fibers have the desired length for the long fibers. In such embodiments, the polymer matrix and continuous fibers (e.g., rovings) are typically pultruded through an impregnation die to achieve the desired contact between the fibers and the polymer. Pultrusion can also help ensure that the fibers are spaced apart and oriented in a longitudinal direction that is parallel to a major axis of the pellet (e.g., length), which further enhances the mechanical properties. Referring to FIG. 1, for instance, one embodiment of a pultrusion process 10 is shown in which a polymer matrix (or component of the polymer matrix) is supplied from an extruder 13 to an impregnation die 11 while continuous fibers 12 are a pulled through the die 11 via a puller device 18 to produce a composite structure 14. Typical puller devices may include, for example, caterpillar pullers and reciprocating pullers. While optional, the composite structure 14 may also be pulled through a coating die 15 that is attached to an extruder 16 through which a coating resin is applied to form a coated structure 17. As shown in FIG. 1, the coated structure 17 is then pulled through the puller assembly 18 and supplied to a pelletizer 19 that cuts the structure 17 into the desired size for forming the long fiber-reinforced composition.

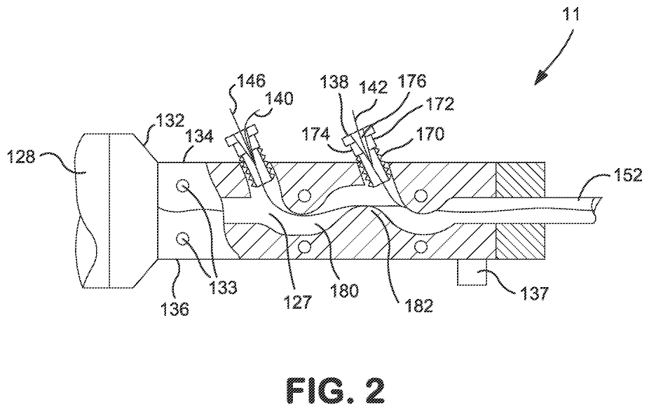

The nature of the impregnation die employed during the pultrusion process may be selectively varied to help achieved good contact between the polymer matrix and the long fibers. Examples of suitable impregnation die systems are described in detail in Reissue Patent No. 32,772 to Hawley; U.S. Pat. No. 9,233,486 to Regan, et al.; and U.S. Pat. No. 9,278,472 to Eastep, et al. Referring to FIG. 2, for instance, one embodiment of such a suitable impregnation die 11 is shown. As shown, a polymer formulation 127, which may include the propylene impact copolymer, may be supplied to the impregnation die 11 via an extruder (not shown). More particularly, the polymer formulation 127 may exit the extruder through a barrel flange 128 and enter a die flange 132 of the die 11. The die 11 contains an upper die half 134 that mates with a lower die half 136. Continuous fibers 142 (e.g., roving) are supplied from a reel 144 through feed port 138 to the upper die half 134 of the die 11. Similarly, continuous fibers 146 are also supplied from a reel 148 through a feed port 140. The polymer formulation 127 is heated inside die halves 134 and 136 by heaters 133 mounted in the upper die half 134 and/or lower die half 136. The die is generally operated at temperatures that are sufficient to cause melting and impregnation of the polymer. Typically, the operation temperatures of the die is higher than the melt temperature of the polymer formulation. When processed in this manner, the continuous fibers 142 and 146 become embedded in the polymer formulation 127. The mixture is then pulled through the impregnation die 11 to create a fiber-reinforced composition 152. If desired, a pressure sensor 137 may also sense the pressure near the impregnation die 11 to allow control to be exerted over the rate of extrusion by controlling the rotational speed of the screw shaft, or the federate of the feeder.

Within the impregnation die, it is generally desired that the fibers contact a series of impingement zones. At these zones, the polymer melt may flow transversely through the fibers to create shear and pressure, which significantly enhances the degree of impregnation. This is particularly useful when forming a composite from ribbons of a high fiber content. Typically, the die will contain at least 2, in some embodiments at least 3, and in some embodiments, from 4 to 50 impingement zones per roving to create a sufficient degree of shear and pressure. Although their particular form may vary, the impingement zones typically possess a curved surface, such as a curved lobe, rod, etc. The impingement zones are also typically made of a metal material.

FIG. 2 shows an enlarged schematic view of a portion of the impregnation die 11 containing multiple impingement zones in the form of lobes 182. It should be understood that this invention can be practiced using a plurality of feed ports, which may optionally be coaxial with the machine direction. The number of feed ports used may vary with the number of fibers to be treated in the die at one time and the feed ports may be mounted in the upper die half 134 or the lower die half 136. The feed port 138 includes a sleeve 170 mounted in upper die half 134. The feed port 138 is slidably mounted in a sleeve 170. The feed port 138 is split into at least two pieces, shown as pieces 172 and 174. The feed port 138 has a bore 176 passing longitudinally therethrough. The bore 176 may be shaped as a right cylindrical cone opening away from the upper die half 134. The fibers 142 pass through the bore 176 and enter a passage 180 between the upper die half 134 and lower die half 136. A series of lobes 182 are also formed in the upper die half 134 and lower die half 136 such that the passage 210 takes a convoluted route. The lobes 182 cause the fibers 142 and 146 to pass over at least one lobe so that the polymer matrix inside the passage 180 thoroughly contacts each of the fibers. In this manner, thorough contact between the molten polymer and the fibers 142 and 146 is assured.

To further facilitate impregnation, the fibers may also be kept under tension while present within the impregnation die. The tension may, for example, range from about 5 to about 300 Newtons, in some embodiments from about 50 to about 250 Newtons, and in some embodiments, from about 100 to about 200 Newtons per tow of fibers. Furthermore, the fibers may also pass impingement zones in a tortuous path to enhance shear. For example, in the embodiment shown in FIG. 2, the fibers traverse over the impingement zones in a sinusoidal-type pathway. The angle at which the rovings traverse from one impingement zone to another is generally high enough to enhance shear, but not so high to cause excessive forces that will break the fibers. Thus, for example, the angle may range from about 1° to about 300°, and in some embodiments, from about 5° to about 25°.

The impregnation die shown and described above is but one of various possible configurations that may be employed in the present invention. In alternative embodiments, for example, the fibers may be introduced into a crosshead die that is positioned at an angle relative to the direction of flow of the polymer melt. As the fibers move through the crosshead die and reach the point where the polymer exits from an extruder barrel, the polymer is forced into contact with the fibers. It should also be understood that any other extruder design may also be employed, such as a twin screw extruder. Still further, other components may also be optionally employed to assist in the impregnation of the fibers. For example, a “gas jet” assembly may be employed in certain embodiments to help uniformly spread a bundle or tow of individual fibers, which may each contain up to as many as 24,000 fibers, across the entire width of the merged tow. This helps achieve uniform distribution of strength properties in the ribbon. Such an assembly may include a supply of compressed air or another gas that impinges in a generally perpendicular fashion on the moving fiber tows that pass across the exit ports. The spread fiber bundles may then be introduced into a die for impregnation, such as described above.

The fiber-reinforced composition may generally be employed to form a shaped part using a variety of different techniques. Suitable techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the fiber-reinforced composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the fiber-reinforced composition into the desired article also occurs within a mold. The composition may be placed into the compression mold using any known technique, such as by being picked up by an automated robot arm. The temperature of the mold may be maintained at or above the solidification temperature of the polymer matrix for a desired time period to allow for solidification. The molded product may then be solidified by bringing it to a temperature below that of the melting temperature. The resulting product may be de-molded. The cycle time for each molding process may be adjusted to suit the polymer matrix, to achieve sufficient bonding, and to enhance overall process productivity.

The present invention may be better understood with reference to the following examples.

### Test Methods and Definitions

“F_{c}” generally refers to the percent by weight of the dispersed phase in a propylene impact copolymer. Fe is equal to the ratio of amount of dispersed phase to the total amount of material made, which can readily be determined by mass balance or using Fourier transform infrared spectroscopy (“FTIR”) as known the art. For impact copolymers containing a comonomer in the continuous phase, the mass balance method may be a more applicable method to determine F_{c}. For impact copolymers containing no comonomer in the continuous phase, FTIR may be more applicable method. Alternatively, for impact copolymers containing no comonomer in the continuous phase, the dispersed phase content in the impact copolymer may also be assessed by determining the amount of material that remains soluble in xylene at room temperature. Xylene Solubles (“XS”) may be measured according to the following procedure. 0.4 g of polymer is dissolved in 20 mL of xylenes with stirring at 130° C. for 30 minutes. The solution is then cooled to 25° C. and after 30 minutes the insoluble polymer fraction is filtered off. The resulting filtrate is analyzed by Flow Injection Polymer Analysis using a Viscotek ViscoGEL H-100-3078 column with THF mobile phase flowing at 1.0 mL/min. The column is coupled to a Viscotek Model 302 Triple Detector Array, with light scattering, viscometer and refractometer detectors operating at 45° C. Instrument calibration may be maintained with Viscotek PolyCAL™ polystyrene standards. The amount of xylene solubles measured by this Viscotek method may correspond to the amount of dispersed rubber phase (F_{c}) in the impact copolymer.

“E_{c}” generally refers to the ethylene content percent by weight in the dispersed phase and is calculated as E_{c}=[Eₜₒₜ−Eₘ(1−F_{c})]/F_{c}.

“Eₘ” generally refers to the weight percent of comonomer (typically ethylene) in the continuous phase. Eₘ can be determined during production using the mass-energy balance method as generally known in the art. Eₘ can also be determined by isolating a sample of the matrix polymer and analyzing using FTIR as known the art. Eₘ can also be estimated by analyzing the entire impact copolymer using the melting point as determined by differential scanning calorimetry.

“Eₜₒₜ” generally refers to the total percent by weight comonomer (typically ethylene) in the propylene impact copolymer, and may be measured by the method reported by S. Di Martino and M. Kelchtermans “Determination of the Composition of Ethylene-Propylene Rubbers Using ^{13C}-NMR Spectroscopy” J. of Applied Polymer Science, 1995, 56, 1781-1787.

“β/α” is conceptually the ratio of the dispersed phase molecular weight to the continuous phase molecular weight. It is normally measured as the intrinsic viscosity (“IV”) of the dispersed phase divided by the IV of the continuous phase. Alternatively, β/α may be determined by the ratio of the melt flow rate of the matrix polymer reactor product (typically Reactor No. 1) to that of the overall impact copolymer reactor product (typically Reactor No. 2), according to the following equation, with both melt flows measured on stabilized powder samples: β/α=[(MFR₁/MFR₂)^{0.213}−1]/(F_{c}/100)+1, where MFR₁ is the continuous phase only and MFR₂ is the overall impact copolymer.

Melt flow rate: The melt flow rate of a polymer or polymer composition may be determined in accordance with ISO 1133-1:2022 (technically equivalent to ASTM D1238-20) at a load of 2.16 kg and temperature of 230° C.

Spiral Flow Length: The term “spiral flow length” generally refers to the length reached by the flow of the composition in a spiral flow channel when it is injected at constant injection temperature and injection pressure from a central gate of a mold in which the spiral flow channel is formed. The spiral flow length may be determined in accordance with ASTM D3121-09 at a barrel temperature of 230° C., molding temperature of 40° C. to 60° C., and a maximum injection pressure of 860 bar.

Toluene Volatile Organic Content (“TVOC”): The toluene-equivalent volatile organic content may be determined in accordance with an automotive industry standard test known as VDA 278:2002. More particularly, measurements may be made on a sample using a thermal desorption analyzer (“TDSA”), such as supplied by Gerstel using helium 5.0 as carrier gas and a column HP Ultra 2 of 50 m length and 0.32 mm diameter and 0.52 μm coating of 5% phenylmethylsiloxane. The analysis may, for example, be performed using device setting 1 and the following parameters: flow mode of splitless, final temperature of 90° C.; final time of 30 min, and rate of 60 K/min. The cooling trap may be purged with a flow-mode split of 1:30 in a temperature range from −150° C. to +280° C. with a heating rate of 12 K/sec and a final time of 10 min. For analysis, the gas chromatography (“GC”) settings may be 2 min isothermal at 40° C., heating at 3 K/min up to 90° C., then at 5 K/min up to 160° C., and then at 10 K/min up to 280° C., 10 minutes isothermal, and flow of 1.3 ml/min. After testing, the TVOC amount is calculated by dividing the amount of volatiles (micrograms of toluene equivalents) by the weight (grams) of the composition. Samples can vary in size and shape to accommodate the thermal desorption tubes. A common size is 1-2 mm×1-2 mm.

Fogging Content (“FOG”): The fogging content may be determined in accordance with an automotive industry standard test known as VDA 278:2002. More particularly, measurements may be made on a sample using a thermaldesoprtion analyzer (“TDSA”), such as supplied by Gerstel using helium 5.0 as carrier gas and a column HP Ultra 2 of 50 m length and 0.32 mm diameter and 0.52 μm coating of 5% phenylmethylsiloxane. The analysis may, for example, be performed using device setting 1 and the following parameters: flow mode of splitless, final temperature of 120° C.; final time of 60 min, and rate of 60 K/min. The cooling trap may be purged with a flow-mode split of 1:30 in a temperature range from −150° C. to +280° C. with a heating rate of 12 K/sec, then a 10 min hold time. For analysis, the gas chromatography (“GC”) settings may be 2 min isothermal at 50° C., heating at 25 K/min up to 160° C., then at 10 K/min up to 280° C., 30 minutes isothermal, and flow of 1.3 ml/min. After testing, the FOG amount is calculated by dividing the amount of volatiles (micrograms of hexadecane equivalents) by the weight (grams) of the composition.

Odor Value: The odor value may be determined in accordance with VDA 270:2016. The test is performed on materials and components of motor vehicle trim and on parts in contact with the air introduced into the vehicle interior. The test equipment includes a heating chamber as specified in DIN 12880. Test vessels are 1-litre glass containers with odorless seal and lid. The specimen quantity is specified in three steps as described in Table 1 of the test method. The assignment to variants A/B/C is made according to the proportional quantity of material used in the vehicle interior. For the examples below, C3 was tested. The glass volume of 1-litre is standard and is where the test samples are placed and then inserted in the pre-heated thermal chamber at the prescribed temperature and time. The test vessels are then removed from the thermal chamber and allowed to cool down to a test temperature of 60° C. prior to being tested. Approval tests are made by at least three testers. The measurement is repeated by at least five testers when the grades of individual tests differ by more than 2 points. For the odor testing, the cover of the test vessels is lifted as little as possible for minimizing the air exchange with the environment. The odor evaluation is made for the variants A, B and C, using a grading system from 1 to 6, with half-steps being allowed. The evaluation scaled is as follows; Grade 1 is not perceptible; Grade 2 is perceptible but not disturbing; and Grade 3 is clearly perceptible but not disturbing; Grade 4 is disturbing Grade 5 and strongly disturbing; and Grade 6 is not acceptable. The “odor value” is indicated as an arithmetic mean of the individual grades, the value being rounded down to half-step grades.

Tensile Modulus, Tensile Stress, and Tensile Elongation at Break: Tensile properties may be tested according to ISO 527-2/1A:2019 (technically equivalent to ASTM D638). Modulus and strength measurements may be made on a dogbone-shaped test strip sample having a length of 170/190 mm, thickness of 4 mm, and width of 10 mm. The testing temperature may be −30° C. or 23° C. and the testing speeds may of 5 mm/min.

Flexural Modulus, Flexural Elongation at Break, and Flexural Stress: Flexural properties may be tested according to ISO 178:2019 (technically equivalent to ASTM D790). This test may be performed on a 64 mm support span. Tests may be run on the center portions of uncut ISO 527 multi-purpose bars. The testing temperature may be 23° C. and the testing speed may be 10 mm/min.

Unnotched and Notched Charpy Impact Strength: Charpy properties may be tested according to ISO Test No. ISO 179-1:2010) (technically equivalent to ASTM D256-10, Method B). This test may be run using a Type 1 specimen size (length of 80 mm, width of 10 mm, and thickness of 4 mm). When testing the notched impact strength, the notch may be a Type A notch (0.25 mm base radius). Specimens may be cut from the center of a multi-purpose bar using a single tooth milling machine. The testing temperature may be −30° C. or 23° C.

### EXAMPLE 1

A concentrate is initially formed that contains approximately 35.5 wt. % of a propylene impact copolymer (melt flow rate of 50 g/10 min, density of 0.9 g/cm³), 60 wt. % continuous glass fiber rovings (2400 Tex, filament diameter of 16 μm), and 4.5 wt. % of additives (e.g., black pigment and stabilizers). The concentrate is melt processed in a twin screw extruder which the melt temperature is 305° C., the die temperature is 310° C., the zone temperatures range from 170° C. to 310° C., and the screw speed is 388 rpm.

### EXAMPLE 2

The concentrate of Example 1 is blended down with a metallocene-catalyzed propylene homopolymer (melt flow rate of 60 g/10 min, density of 0.900 g/cm³) so that the glass rovings are present in an amount of 20 wt. %.

### EXAMPLE 3

The concentrate of Example 1 is blended down with a mixture containing a metallocene-catalyzed propylene homopolymer (melt flow rate of 60 g/10 min, density of 0.900 g/cm³) and an impact modifier so that the glass rovings are present in an amount of 20 wt. % and the impact modifier is present in an amount of 6 wt. %. The impact modifier is a metallocene-catalyzed ethylene-1-octene copolymer (melt flow rate of 5 g/10 min, density of 0.87 g/cm³).

### EXAMPLE 4

A sample is formed as described in Example 3, except that the impact modifier is present in an amount of 10 wt. %.

### EXAMPLE 5

The concentrate of Example 1 is blended down with a metallocene-catalyzed propylene homopolymer (melt flow rate of 25 g/10 min, density of 0.900 g/cm³) so that the glass rovings are present in an amount of 20 wt. %.

### EXAMPLE 6

The concentrate of Example 1 is blended down with a mixture containing a metallocene-catalyzed propylene homopolymer (melt flow rate of 25 g/10 min, density of 0.900 g/cm³) and an impact modifier so that the glass rovings are present in an amount of 20 wt. % and the impact modifier is present in an amount of 6 wt. %. The impact modifier is a metallocene-catalyzed ethylene-1-octene copolymer (melt flow rate of 5 g/10 min, density of 0.87 g/cm³).

### EXAMPLE 7

A sample is formed as described in Example 6, except that the impact modifier is present in an amount of 10 wt. %.

Molded specimens having a thickness of 4 mm are formed from the samples of Examples 2-7 using the following process conditions: nozzle temperature of 230-240° C., injection pressure of 600-1200 bar, back pressure of 0-50 bar, and melt temperature of 230-250° C. The parts are then tested for mechanical properties, emissions, and odor as described above. The results are set forth in the tables below.

| | Units | Ex. 2 | Ex. 3 | Ex. 4 | Ex. 5 | Ex. 6 | Ex. 7 |
|---|---|---|---|---|---|---|---|
| Tensile modulus (1 mm/min) 23° C. | MPa | 5,410 | 4,710 | 4,680 | 4,650 | 4,670 | 4,720 |
| Tensile strength 23° C. | MPa | 101.4 | 95.3 | 95.1 | 89.5 | 91.1 | 92.5 |
| Tensile strain @ break (5 mm/min) 23° C. | % | 2.5 | 2.7 | 2.7 | 2.6 | 2.6 | 2.6 |
| Unnotched Charpy impact strength 23° C. | KJ/m² | 53 | 58 | 58 | 55 | 59 | 59 |
| Unnotched Charpy impact strength −30° C. | KJ/m² | 42 | 61 | 60 | 52 | 75 | 53 |
| Charpy Notched impact strength 23º C. | KJ/m² | 15 | 19 | 21 | 18 | 21 | 20 |
| Charpy notched impact strength −30° C. | KJ/m² | 21 | 23 | 21 | 17 | 21 | 22 |
| Spiral Flow | T = 2 mm | 759 | 709 | 737 | 608 | 617 | 601 |
| Odor Value (tensile bars) | — | 4.8 | 4.3 | 4.0 | 4.3 | 4.5 | 4.0 |
| TVOC (pellets) | μC/g | 22 | 11 | 7 | 30 | 13 | 10 |
| FOG (pellets) | μg/g | 164 | 109 | 109 | 140 | 137 | 121 |

### EXAMPLE 8

A concentrate is initially formed that contains approximately 35.5 wt. % of a propylene impact copolymer (melt flow rate of 44 g/10 min, density of 0.9 g/cm³, 60 wt. % continuous glass fiber rovings (2400 Tex, filament diameter of 16 μm), and 4.5 wt. % of additives (e.g., black pigment and stabilizers). The concentrate is melt processed in a single screw extruder in which the melt temperature is 305° C., the die temperature is 310° C., the zone temperatures range from 170° C. to 310° C., and the screw speed is 388 rpm.

### EXAMPLE 9

The concentrate of Example 8 is blended down with a metallocene-catalyzed propylene homopolymer (melt flow rate of 60 g/10 min, density of 0.900 g/cm³) so that the glass rovings are present in an amount of 20 wt. %.

### EXAMPLE 10

The concentrate of Example 8 is blended down with a mixture containing a metallocene-catalyzed propylene homopolymer (melt flow rate of 60 g/10 min, density of 0.900 g/cm³) and an impact modifier so that the glass rovings are present in an amount of 20 wt. % and the impact modifier is present in an amount of 6 wt. %. The impact modifier is a metallocene-catalyzed ethylene-1-octene copolymer (melt flow rate of 5 g/10 min, density of 0.87 g/cm³).

### EXAMPLE 11

A sample is formed as described in Example 10, except that the impact modifier is present in an amount of 10 wt. %.

### EXAMPLE 12

The concentrate of Example 8 is blended down with a metallocene-catalyzed propylene homopolymer (melt flow rate of 25 g/10 min, density of 0.900 g/cm³) so that the glass rovings are present in an amount of 20 wt. %.

### EXAMPLE 13

The concentrate of Example 8 is blended down with a mixture containing a metallocene-catalyzed propylene homopolymer (melt flow rate of 25 g/10 min, density of 0.900 g/cm³) and an impact modifier so that the glass rovings are present in an amount of 20 wt. % and the impact modifier is present in an amount of 6 wt. %. The impact modifier is a metallocene-catalyzed ethylene-1-octene copolymer (melt flow rate of 5 g/10 min, density of 0.87 g/cm³).

### EXAMPLE 14

A sample is formed as described in Example 13, except that the impact modifier is present in an amount of 10 wt. %.

Molded specimens having a thickness of 4 mm are formed from the samples of Examples 9-14 using the following process conditions: nozzle temperature of 230-240° C., injection pressure of 600-1200 bar, back pressure of 0-50 bar, and melt temperature of 230-250° C. The parts are then tested for mechanical properties, emissions, and odor as described above. The results are set forth in the tables below.

| | | Ex. | Ex. | Ex. | Ex. | Ex. | Ex. |
|---|---|---|---|---|---|---|---|
| | Units | 9 | 10 | 11 | 12 | 13 | 14 |
| Tensile modulus (1 mm/min) 23° C. | MPa | 4,980 | 4,710 | 4,820 | 4,810 | 4,720 | 4,700 |
| Tensile strength 23° C. | MPa | 93.7 | 95.1 | 95.5 | 89.7 | 92.5 | 92.6 |
| Tensile strain @ break (5 mm/min) 23° C. | % | 2.5 | 2.7 | 2.6 | 2.5 | 2.6 | 2.7 |
| Unnotched Charpy impact strength 23°C. | KJ/m² | 46 | 61 | 60 | 52 | 59 | 58 |
| Unnotched Charpy impact strength −30°C. | KJ/m² | 37 | 47 | 40 | 40 | 35 | — |
| Charpy Notched impact strength 23° C. | KJ/m² | 14 | 21 | 21 | 16 | 20 | 24 |
| Charpy notched impact strength −30° C. | KJ/m² | 17 | 22 | 20 | 17 | 21 | — |
| Spiral Flow | T = 2 mm | 761 | 709 | 709 | 627 | 601 | 611 |
| Odor Value (tensile bars) | — | 3.8 | 3.5 | 4.0 | 3.3 | 3.8 | 3.8 |
| TVOC (pellets) | μC/g | 20 | 10 | 12 | 19 | 11 | 11 |
| FOG (pellets) | μg/g | 152 | 105 | 134 | 132 | 93 | 103 |

### EXAMPLE 15

A concentrate is initially formed that contains approximately 35.5 wt. % of a propylene impact copolymer (melt flow rate of 100 g/10 min, density of 0.9 g/cm³), 60 wt. % continuous glass fiber rovings (2400 Tex, filament diameter of 16 μm), and 4.5 wt. % of additives (e.g., black pigment and stabilizers). The concentrate is melt processed in a single screw extruder in which the melt temperature is 310° C., the die temperature is 310° C., the zone temperatures range from 170° C. to 310° C., and the screw speed is 388 rpm.

### EXAMPLE 16

The concentrate of Example 15 is blended down with a metallocene-catalyzed propylene homopolymer (melt flow rate of 60 g/10 min, density of 0.900 g/cm³) so that the glass rovings are present in an amount of 20 wt. %.

### EXAMPLE 17

The concentrate of Example 15 is blended down with a mixture containing a metallocene-catalyzed propylene homopolymer (melt flow rate of 60 g/10 min, density of 0.900 g/cm³) and an impact modifier so that the glass rovings are present in an amount of 20 wt. % and the impact modifier is present in an amount of 6 wt. %. The impact modifier is a metallocene-catalyzed ethylene-1-octene copolymer (melt flow rate of 5 g/10 min, density of 0.87 g/cm³).

### EXAMPLE 18

A sample is formed as described in Example 17, except that the impact modifier is present in an amount of 10 wt. %.

### EXAMPLE 19

The concentrate of Example 15 is blended down with a metallocene-catalyzed propylene homopolymer (melt flow rate of 25 g/10 min, density of 0.900 g/cm³) so that the glass rovings are present in an amount of 20 wt. %.

### EXAMPLE 20

The concentrate of Example 15 is blended down with a mixture containing a metallocene-catalyzed propylene homopolymer (melt flow rate of 25 g/10 min, density of 0.900 g/cm³) and an impact modifier so that the glass rovings are present in an amount of 20 wt. % and the impact modifier is present in an amount of 6 wt. %. The impact modifier is a metallocene-catalyzed ethylene-1-octene copolymer (melt flow rate of 5 g/10 min, density of 0.87 g/cm³).

### EXAMPLE 21

A sample is formed as described in Example 20, except that the impact modifier is present in an amount of 6 wt. %.

Molded specimens having a thickness of 4 mm are formed from the samples of Examples 16-21 using the following process conditions: nozzle temperature of 230-240° C., injection pressure of 600-1200 bar, back pressure of 0-50 bar, and melt temperature of 230-250° C. The parts are then tested for mechanical properties, emissions, and odor as described above. The results are set forth in the tables below.

| | | Ex. | Ex. | Ex. | Ex. | Ex. | Ex. |
|---|---|---|---|---|---|---|---|
| | Units | 16 | 17 | 18 | 19 | 20 | 21 |
| Tensile modulus (1 mm/min) 23° C. | MPa | 5,260 | 4,930 | 4,850 | 4,870 | 4,530 | 4,700 |
| Tensile strength 23° C. | MPa | 98.4 | 98.0 | 97.3 | 90.0 | 90.5 | 91.8 |
| Tensile strain @ break (5 mm/min) 23° C. | % | 2.5 | 2.6 | 2.7 | 2.5 | 2.7 | 2.6 |
| Unnotched Charpy impact strength 23° C. | KJ/m² | 54 | 58 | 64 | 50 | 58 | 61 |
| Unnotched Charpy impact strength −30° C. | KJ/m² | 33 | 55 | 42 | 38 | 50 | 37 |
| Charpy Notched impact strength 23° C. | KJ/m² | 14 | 20 | 21 | 15 | 19 | 21 |
| Charpy notched impact strength −30° C. | KJ/m² | 18 | 21 | 21 | 17 | 23 | 21 |
| Spiral Flow | T = 2 mm | 781 | 711 | 731 | 640 | 637 | 626 |
| Odor Value (tensile bars) | — | 3.3 | 4.0 | 4.2 | 3.3 | 4.2 | 4.0 |
| TVOC (pellets) | μC/g | 23 | 73 | 31 | 19 | — | 16 |
| FOG (pellets) | μg/g | 195 | 319 | 246 | 173 | — | 144 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A fiber-reinforced polymer composition comprising:
a polymer matrix that constitutes from about 30 wt. % to about 90 wt. % of the composition, wherein the polymer matrix contains a propylene impact copolymer having a first melt flow rate of from about 10 to about 100 grams per 10 minutes as determined in accordance with ISO 1133-1:2022 at a load of 2.16 kg and temperature of 230° C. and a metallocene-catalyzed propylene homopolymer having a second melt flow rate of from about 10 to about 100 grams per 10 minutes as determined in accordance with ISO 1133-1:2022 at a load of 2.16 kg and temperature of 230° C., wherein the ratio of the second melt flow rate to the first melt flow rate is from about 0.1 to about 2; and
a plurality of long reinforcing fibers that are distributed within the polymer matrix, wherein the fibers constitute from about 10 wt. % to about 70 wt. % of the composition;
wherein the composition exhibits a toluene equivalent volatile organic content of about 50 μgC/g or less as determined in accordance with VDA 278:2002.

2. The fiber-reinforced polymer composition of claim 1, wherein the composition exhibits a fogging content of about 250 μg/g or less as determined in accordance with VDA 278:2002.

3. The fiber-reinforced polymer composition of claim 1, wherein the polymer composition exhibits an odor value of about 4.5 or less, as determined in accordance with VDA 270:2016.

4. The fiber-reinforced polymer composition of claim 1, wherein the propylene impact copolymer includes a heterophasic copolymer.

5. The fiber-reinforced polymer composition of claim 4, wherein the heterophasic copolymer contains a continuous phase and a dispersed phase, wherein the continuous phase contains a propylene polymer containing 0 to 10 mol. % of one or more units derived from an α-olefin, and wherein the dispersed phase includes an olefin copolymer.

6. The fiber-reinforced polymer composition of claim 1, wherein propylene impact copolymers constitute from about 2 wt. % to about 35 wt. % of the polymer matrix and metallocene-catalyzed homopolymers constitute from about 50 wt. % to about 95 wt. % of the polymer matrix.

7. The fiber-reinforced polymer of claim 1, wherein propylene impact copolymers constitute from about 1 wt. % to about 30 wt. % of the polymer composition and metallocene-catalyzed propylene homopolymers constitute from about 40 wt. % to about 85 wt. % of the polymer composition.

8. The fiber-reinforced polymer composition of claim 1, wherein the fibers are glass fibers.

9. The fiber-reinforced polymer composition of claim 1, wherein the fibers constitute from about 20 wt. % to about 60 wt. % of the composition.

10. The fiber-reinforced polymer composition of claim 1, wherein the fibers are oriented in a longitudinal direction of the composition.

11. The fiber-reinforced polymer composition of claim 1, wherein the polymer composition exhibits a spiral flow length of about 900 millimeters or more as determined in accordance with ASTM D3121-09.

12. The fiber-reinforced polymer composition of claim 1, wherein the polymer composition exhibits a Charpy notched impact strength of greater than about 15 kJ/m² as determined at a temperature of about 23° C. in accordance with ISO 179-1:2010.

13. The fiber-reinforced polymer composition of claim 1, wherein the polymer composition exhibits a Charpy notched impact strength of greater than about 15 kJ/m² as determined at a temperature of about −30° C. in accordance with ISO 179-1:2010.

14. The fiber-reinforced polymer composition of claim 1, wherein the polymer composition further comprises an impact modifier.

15. The fiber-reinforced polymer composition of claim 14, wherein the impact modifier includes an olefin elastomer.

16. The fiber-reinforced polymer composition of claim 15, wherein the olefin elastomer includes an ethylene/α-olefin copolymer.

17. The fiber-reinforced polymer composition of claim 16, wherein the ethylene/α-olefin copolymer has a melt flow rate of from about 0.1 to about 50 grams per 10 minutes, as determined in accordance with ISO 1133-1:2022 at a load of 2.16 kilograms and temperature of about 190° C.

18. The fiber-reinforced polymer composition of claim 15, wherein the olefin elastomer has a Shore A hardness of about 200 or less, as determined in accordance with ASTM D2240-15(2021).

19. The fiber-reinforced polymer composition of claim 15, wherein the olefin elastomer has a flexural modulus of about 100 MPa or less, as determined in accordance with ISO 178:2019.

20. The fiber-reinforced polymer composition of claim 1, wherein the propylene impact copolymer and the metallocene-catalyzed propylene homopolymer have a density of about 0.95 grams per cubic centimeter or less, as determined in accordance with ISO 1183-1:2019.

21. A method for forming a fiber-reinforced composition comprising:
extruding a propylene impact copolymer through an impregnation die and pulling a plurality of long reinforcing fibers through the impregnation die for contact with the copolymer to form a concentrate, wherein the propylene impact copolymer has a first melt flow rate of from about 10 to about 100 grams per 10 minutes as determined in accordance with ISO 1133-1:2022 at a load of 2.16 kg and temperature of 230° C.; and
blending a metallocene-catalyzed propylene homopolymer with the concentrate to form a polymer composition, wherein the metallocene-catalyzed propylene homopolymer has a second melt flow rate of from about 10 to about 100 grams per 10 minutes as determined in accordance with ISO 1133-1:2022 at a load of 2.16 kg and temperature of 230° C., wherein the ratio of the second melt flow rate to the first melt flow rate is from about 0.1 to about 2.

22. The method of claim 21, wherein the long reinforcing fibers constitute from about 10 wt. % to about 70 wt. % of the composition.

23. An injection molded part comprising the fiber-reinforced polymer composition of claim 1, wherein the part has a wall thickness of about 2.5 millimeters or less.

24. An automotive part comprising the fiber-reinforced polymer composition of claim 1.

25. The automotive part of claim 24, wherein the part is injection molded.

26. The automotive part of claim 24, wherein the part is an interior automotive part.

27. The automotive part of claim 24, wherein the part is a pedal module, instrument panel, arm rest, console, seat structure, interior module, lift gate, interior organizer, step assist, ash tray, glove box, gear shift lever, or a combination thereof.
